(19) United States
(12) Patent Application Publication
(10) Pub. No.: US 2026/0126322 A1
(43) Pub. Date: May 7, 2026

(54) DOUBLE-LAYER TURRET MULTI-GRATING ON-AXIS ROTATION MODULE AND SPECTROMETER

(71) Applicant: Zolix Analytical Instruments Co., Ltd., Beijing (CN)

(72) Inventors: Jing Chen, Beijing City (CN); Fei Tong, Beijing (CN); Hongtai Cai, Beijing City (CN); Xinghai Chen, Beijing City (CN)

(73) Assignee: ZOLIX INSTRUMENTS Co., Ltd., Beijing City (CN)

(21) Appl. No.: 19/381,374

(22) Filed: Nov. 6, 2025

(30) Foreign Application Priority Data
Nov. 6, 2024 (CN) 202411572223.5

(51) Int. Cl. G01J 3/06; G01J 3/18

(52) U.S. Cl. CPC G01J 3/06; G01J 3/18

(57) ABSTRACT

The present disclosure relates to a double-layer turret multi-grating on-axis rotation module and a spectrometer. The module includes a grating turret assembly, and the grating turret assembly includes a turret base and a plurality of grating elements provided on the turret base; a first rotation assembly, and the turret base is connected to the first rotation assembly, a rotation axis of the first rotation assembly and a central axis of the plurality of grating elements are on a same vertical line, and the grating turret assembly is driven to rotate by the first rotation assembly; a second rotation assembly, and the first rotation assembly is connected to the second rotation assembly.

### CROSS-REFERENCE TO RELATED APPLICATION

The present disclosure claims priority to Chinese Patent Application No. 202411572223.5, filed on Nov. 6, 2024, which is herein incorporated by reference in its entirety.

### TECHNICAL FIELD

The present disclosure relates to the technical field of spectrometer spectral splitting, and particular to a double-layer turret multi-grating on-axis rotation module and a spectrometer.

### BACKGROUND

A spectrometer is a scientific instrument that uses dispersive elements to decompose light with complex components into the desired wavelength or the wavelength region, and measures the intensity at the selected wavelength (or scanning over a specific spectral range). In order to better leverage the advantages of the spectrometer in covering the full spectral range and to more flexibly select the spectral range and resolution, it is necessary to introduce a multi-grating turret to meet the design requirements.

At present, the multi-grating turret is mostly designed using the principle of “triangular prism”. The rotation axis of the grating is positioned at the center point of the “triangular prism”, which leads to the rotational axis of the grating to deviate from its theoretical position. The larger the clear aperture of the grating, the farther the actual rotation axis of the grating deviates from the theoretical rotation axis, thereby increasingly impairing the utilization efficiency of the grating.

Aiming at the problem in the related art that the multi-grating spectrometer suffers from the deviation in the grating rotational axis, which adversely affects the utilization efficiency of the grating.

Therefore, by drawing on years of experience and practice in the relevant field, the present inventor proposes a double-layer turret multi-grating on-axis rotation module and a spectrometer to overcome the limitations of the prior art.

### SUMMARY

The present disclosure aims to provide a double-layer turret multi-grating on-axis rotation module and a spectrometer, which can avoid the deviation of the grating rotation axis, realize the on-axis rotation of the grating, effectively improve the utilization efficiency of the grating and improve the instrument performance of the spectrometer under the same conditions.

The object of the present disclosure can be achieved by the following solutions:

The present disclosure provides a double-layer turret multi-grating on-axis rotation module, the module including:
a grating turret assembly, and the grating turret assembly includes a turret base and a plurality of grating elements with different spectral resolutions, and the plurality of grating elements are vertically arranged on a top face of the turret base, and the plurality of grating elements are arranged in a coordinated manner to form a polygonal prism structure;
a first rotation assembly, and the first rotation assembly is disposed below the grating turret assembly, a bottom face of the turret base is connected to the top of the first rotation assembly, a rotation axis of the first rotation assembly is on a same vertical line as a central axis of a plurality of grating elements, and the grating turret assembly is driven to rotate by the first rotation assembly to change the grating elements receiving light; and
a second rotation assembly, and the second rotation assembly is disposed below the first rotation assembly, a bottom of the first rotation assembly is connected to a top of the second rotation assembly, and a rotation axis of the second rotation assembly is offset vertically from the rotation axis of the first rotation assembly;
in the horizontal direction, the distance between the rotation axis of the second rotation assembly and the rotation axis of the first rotation assembly is equal to the distance between the rotation axis of the first rotation assembly and the grating element, so that the grating element receiving light and the rotation axis of the second rotation assembly are located on a same vertical line, and the first rotation assembly is driven to rotate by the second rotation assembly.

In an optional embodiment of the present disclosure, the grating turret assembly further includes a turret main body, the bottom of the turret main body is connected to the top face of the turret base, the outer wall of the turret main body and along the circumferential direction thereof are provided with a plurality of grating brackets, the plurality of grating brackets correspond one-to-one with the plurality of grating elements, and the plurality of grating elements are respectively detachably connected to the corresponding grating brackets.

In an optional embodiment of the present disclosure, the turret main body is a vertically arranged cylindrical structure, a top of the turret main body is provided with a turret cover plate, the rotation axis of the first rotation assembly passes through the turret base from bottom to top and extends into the interior of the turret main body, and the first rotation assembly is connected to the bottom face of the turret base, so that the turret main body is driven to rotate through the first rotation assembly.

In an optional embodiment of the present disclosure, the first rotation assembly includes a base plate, a first column body is disposed at a center of a top of the base plate, the first column body is a vertically arranged hollow columnar structure, a bottom of the first column body is connected to the base plate, and the first column body passes through the turret base from bottom to top and extends into the interior of the turret main body;
the top of the base plate is provided with a first worm gear, the first worm gear is rotatably sleeved on an outer periphery of the first column body, the turret base is positioned above the first worm gear, and the bottom face of the turret base is connected to a top face of the first worm gear;
a side of the first worm gear is provided with a first motor and a first worm, an output shaft of the first motor is connected to an end of the first worm, and teeth on the first worm are meshed with teeth on the first worm gear to drive the first worm gear to rotate through the first motor.

In an optional embodiment of the present disclosure, the first rotation assembly further includes a first central rotation axis, a bottom end of the first central rotation axis is connected to the first worm gear, and the first central rotation axis passes through the bottom opening of the first column body from bottom to top and extends into the interior of the first column body;
a first angular contact ball bearing is provided between the first central rotation axis and the inner wall of the first column body.

In an optional embodiment of the present disclosure, the first motor is disposed on the base plate.

In an optional embodiment of the present disclosure, the second rotation assembly includes a base provided on a mounting table, a rotatable turntable is provided above the base, a second worm gear is provided at a top of the turntable, a top face of the second worm gear is connected to the bottom face of a connection plate, and a top face of the connection plate is connected to a bottom of the base plate; and
a side of the second worm gear is provided with a second motor and a second worm, an output shaft of the second motor is connected to an end of the second worm, and teeth on the second worm are meshed with teeth on the second worm gear to drive the second worm gear to rotate through the second motor.

In an optional embodiment of the present disclosure, a second column body protrudes upward from a center position of the top of the turntable, the second worm gear is sleeved on the outer periphery of the second column body, and the second worm gear is connected to the turntable by a bolt; and
the outer periphery of the second column body is sleeved with a connection plate, the connection plate is located between the top face of the second worm gear and the bottom face of the base plate, and the second worm gear is connected to the base plate by the connection plate.

In an optional embodiment of the present disclosure, the second rotation assembly further includes a worm bracket arranged on the mounting table, the second worm is rotatably disposed on the worm bracket, and an end of the second worm is connected to the output shaft of the second motor through a coupling.

In an optional embodiment of the present disclosure, the second rotation assembly further includes a second central rotation axis, the base is provided with a mounting hole extending vertically, the second central rotation axis is rotatably disposed in the mounting hole, a top end of the second central rotation axis extends from a top opening of the mounting hole and is connected to a bottom face of the turntable; and
a second angular contact ball bearing is provided between the second central rotation axis and the inner wall of the mounting hole.

In an optional embodiment of the present disclosure, a distance between an axis of the first central rotation shaft and an axis of the second central rotation shaft is equal to a distance between the axis of the first central rotation shaft and a vertical centerline of the grating element.

In an optional embodiment of the present disclosure, the second rotation assembly further includes a limit pin and a tension spring, and the limit pin is disposed on the mounting table, an end of the tension spring is connected to the limit pin, and the other end of the tension spring is connected to the turntable to limit the rotation range of the second worm gear.

In an optional embodiment of the present disclosure, the second rotation assembly further includes a first photoelectric sensor, and the first photoelectric sensor is configured to collect an optical signal to determine a rotational angle of the second worm gear.

In an optional embodiment of the present disclosure, the first worm gear is provided with a plurality of light-transmitting holes at positions near an edge thereof, the plurality of light-transmitting holes correspond one-to-one with the plurality of grating elements, and the plurality of light-transmitting holes are distributed at intervals along a circumference of the first worm gear; and
the first rotation assembly further includes a second photoelectric sensor arranged on the mounting table, and the second photoelectric sensor is located on a side of the first worm gear, and the second photoelectric sensor is configured to respectively collect corresponding optical signals when the plurality of light-transmitting holes are sequentially rotated to a position aligned with it.

In an optional embodiment of the present disclosure, the number of grating elements is three, and among the three grating elements, the grating element located on a same vertical line as the rotation axis of the second rotation assembly faces an incident direction of the light.

The present disclosure provides a spectrometer, and the spectrometer includes the aforementioned double-layer turret multi-grating on-axis rotation module.

From the above, the characteristics and advantages of the double-layer turret multi-grating on-axis rotation module and the spectrometer according to the present disclosure are as follows:

According to practical requirements, a plurality of grating elements with different spectral resolutions are vertically provided on the top face of the turret base, and the plurality of grating elements are arranged in a coordinated manner to form a polygonal prism structure, so as to switch between the different grating elements in the subsequent rotation process. The bottom face of the turret base is connected to the top of the first rotation assembly, enabling the first rotation assembly to drive the grating turret assembly to rotate around the rotation axis of the first rotation assembly as a central axis. Since the rotation axis of the first rotation assembly and the central axis of the multiple grating elements lie on a same vertical line, the rotation of the grating turret assembly with the first rotation assembly allows for the switching of grating elements at the position where light can be received. This enables the change of grating elements with different spectral resolutions to receive light as needed.

In addition, the bottom of the first rotation assembly is connected with the top of the second rotation assembly, the rotation axis of the second rotation assembly is offset vertically from the rotation axis of the first rotation assembly, and in a horizontal direction, the distance between the rotation axis of the second rotation assembly and the rotation axis of the first rotation assembly is equal to the distance between the rotation axis of the first rotation assembly and the grating element, so that the grating element receiving light and the rotation axis of the second rotation assembly are located on a same vertical line. As a result, the second rotation assembly can drive the first rotation assembly to rotate, adjusting the angle of the grating element to achieve the purpose of scanning the wavelength along the optical axis for the corresponding grating element. Through the coordination of the multiple grating elements, the first rotation assembly, and the second rotation assembly, this application consistently maintains the alignment of the grating element receiving light and the rotation axis of the second rotation assembly on a same vertical line. This prevents misalignment of the grating rotation axis, enables on-axis rotation of the grating, and effectively improves the utilization efficiency of the grating.

### BRIEF DESCRIPTION OF DRAWINGS

The following drawings are only intended to schematically illustrate and explain the present disclosure, and do not limit the scope of the present disclosure. In the drawings:

FIG. 1 is a perspective view of a double-layer turret multi-grating on-axis rotation module according to the present disclosure.

FIG. 2 is a front sectional view of the double-layer turret multi-grating on-axis rotation module according to the present disclosure.

FIG. 3 is a schematic diagram of the operational principle of the double-layer turret multi-grating on-axis rotation module according to the present disclosure.

FIG. 4 is a schematic diagram of off-axis rotation of a grating in the prior art.

FIG. 5 is a schematic diagram of the on-axis rotation of a grating in the dual-layer turret multi-grating on-axis rotation module according to the present disclosure.

The reference numerals in the present disclosure are:

| | |
|---|---|
| 1. Grating turret assembly; | 101. Grating element; |
| 1011. vertical centerline; | 102. turret base; |
| 103. turret main body; | 104. grating bracket; |
| 105. turret cover plate; | 2. a first rotation assembly; |
| 201. base plate; | 202. first worm gear; |
| 2022. light-transmitting hole; | 203. first motor; |
| 204. first worm; | 205. first column body; |
| 206. first central rotation axis; | 207. first angular contact ball |
| | bearing; |
| 208. second photoelectric sensor; | 3. a second rotation assembly; |
| 301. base; | 3011. mounting hole; |
| 302. turntable; | 3021. second column body; |
| 303. second worm gear; | 304. connection plate; |
| 305. second central rotation axis; | 306. second angular contact ball |
| | bearing; |
| 307. second motor; | 308. second worm; |
| 309. coupling; | 310. worm bracket; |
| 311. limit pin; | 312. tension spring; |
| 313. first photoelectric sensor; | 4. mounting table. |

### DESCRIPTION OF EMBODIMENTS

In order to provide a clearer understanding of the technical features, objectives and effects of the present disclosure, specific embodiments of the present disclosure will now be described with reference to the drawings.

### Embodiment 1

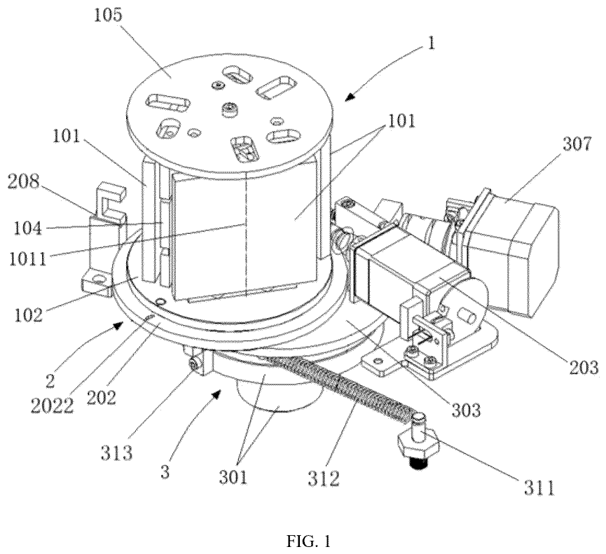

As shown in FIG. 1 to FIG. 3, the present disclosure provides a double-layer turret multi-grating on-axis rotation module, which includes a grating turret assembly 1, a first rotation assembly 2 and a second rotation assembly 3. The grating turret assembly 1 includes a turret base 102 and a plurality of grating elements 101 with different spectral resolutions, and the plurality of grating elements 101 are vertically arranged on a top face of the turret base 102, and the plurality of grating elements are disposed around a periphery of a vertical axis (i.e. the central axis of the turret base 102) serving as the central axis, such that the plurality of grating elements 101 are arranged in a coordinated manner to form a polygonal prism structure. The first rotation assembly 2 is disposed below the grating turret assembly 1, a bottom face of the turret base 102 is connected to the top of the first rotation assembly 2, the rotation axis of the first rotation assembly 2 is on a same vertical line as a central axis of the plurality of grating elements 101 (that is, the vertical line at the center of the plurality of grating elements 101, which is also the central axis of the turret base 102), and the grating turret assembly 1 is driven to rotate by the first rotation assembly 2 to change the grating elements 101 receiving light. The second rotation assembly 3 is disposed below the first rotation assembly 2, a bottom of the first rotation assembly 2 is connected to a top of the second rotation assembly 3, and a rotation axis of the second rotation assembly 3 is offset vertically from the rotation axis of the first rotation assembly 2. In the horizontal direction, the distance between the rotation axis of the second rotation assembly 3 and the rotation axis of the first rotation assembly 2 is equal to the distance between the rotation axis of the first rotation assembly 2 and the grating element 101, so that the grating element 101 receiving light and the rotation axis of the second rotation assembly 3 are located on a same vertical line, and the first rotation assembly 2 is driven to rotate by the second rotation assembly 3.

In the present disclosure, the grating element 101 may be, but is not limited to, a disposed vertically grating plate.

According to practical requirements, a plurality of grating elements 101 with different spectral resolutions are vertically disposed on the top face of the turret base 102, and the plurality of grating elements 101 are arranged in a coordinated manner to form a polygonal prism structure, and each face of the polygonal prism structure corresponds to one grating element 101, so as to switch between different grating elements 101 in the subsequent rotation process to meet the use requirements of different spectral resolutions. The bottom face of the turret base 102 is connected to the top of the first rotation assembly 2, allowing the first rotation assembly 2 to drive the grating turret assembly 1 to rotate around the rotation axis of the first rotation assembly 2 as the central axis. Since the rotation axis of the first rotation assembly 2 and the central axis of the multiple grating elements 101 lie on a same vertical line, vertical centerlines 1011 of the multiple grating elements 101 are equidistant from the rotation axis of the first rotation assembly 2. During the rotation of the grating tower assembly 1 driven by the first rotation assembly 2, switching of the grating element 101 at the light-receiving position can be achieved, thereby allowing the use of grating elements 101 with different spectral resolutions to receive light as needed. In addition, the bottom of the first rotation assembly 2 is connected to the top of the second rotation assembly 3 in the present application, the rotation axis of the second rotation assembly 3 is offset vertically from the rotation axis of the first rotation assembly 2, and in the horizontal direction, the distance between the rotation axis of the second rotation assembly 3 and the rotation axis of the first rotation assembly 2 is equal to the distance between the rotation axis of the first rotation assembly 2 and the grating element 101. This ensures that the grating element 101 receiving light and the rotation axis of the second rotation assembly 3 lie on a same vertical line. Consequently, the second rotation assembly 3 can drive the first rotation assembly 2 to rotate, adjusting the angle of the grating element 101 to achieve wavelength scanning along the optical axis for the corresponding grating element 101. Through the coordination of the multiple grating elements 101, the first rotation assembly 2, and the second rotation assembly 3, this application consistently maintains the alignment of the grating element receiving light and the rotation axis of the second rotation assembly on a same vertical line. This prevents misalignment of the grating rotation axis, enables on-axis rotation of the grating, and effectively improves the utilization efficiency of the grating.

In a specific embodiment of the present disclosure, as shown in FIGS. 1 to 3, the number of the grating elements 101 is three, and the three grating element 101 are arranged in a coordinated manner to form a triangular prism structure. Among the three grating elements 101, the grating element 101 located on a same vertical line as the rotation axis of the second rotation assembly 3 faces the incident direction of light, so that during use, the purpose of scanning the wavelength along the optical axis for the corresponding grating element 101 is achieved.

In an alternative embodiment of the present disclosure, as shown in FIGS. 1 to 3, the grating turret assembly 1 further includes a turret main body 103. The turret main body 103 serves as a supporting structure for the plurality of grating elements 101, the bottom of the turret main body 103 is fixedly connected to the top face of the turret base 102 by a plurality of bolts, and a plurality of grating brackets 104 are uniformly arranged at intervals along the circumference of the outer wall of the tower body 103. The plurality of grating brackets 104 correspond one-to-one with the plurality of grating elements 101, and the plurality of grating elements 101 are detachably connected to their corresponding grating brackets 104, respectively. Among them, the grating bracket 104 may have an actuating component capable of tilting or swiveling movements, and the grating element 101 is connected to the actuating component, thereby enabling adjustment of the pitch angle and yaw angle of the grating elements 101. In this application, the specific structure of the actuating component is not limited herein, as it adopts structural components commonly used for mounting in existing spectrometers. Of course, other devices with multi-axis movement capabilities (such as multi-axis robotic arms) can also be used to adjust the pitch angle and yaw angle of the grating element 101.

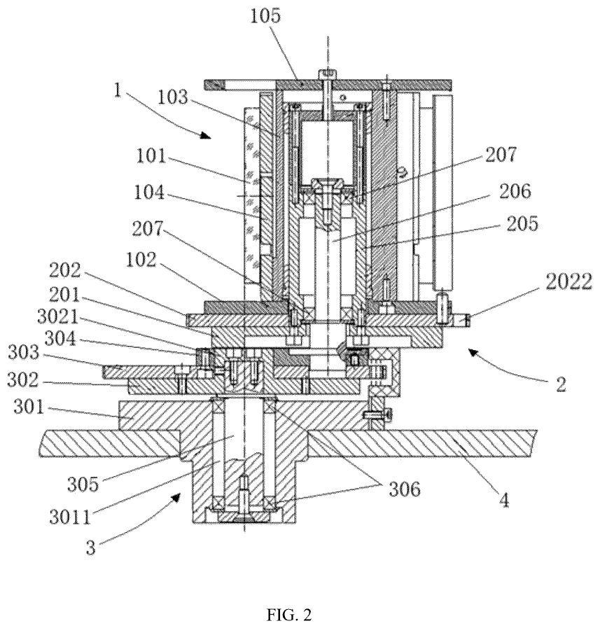

Specifically, as shown in FIGS. 1 and 2, the turret base 102 is a disc-shaped structure arranged horizontally, the turret main body 103 is a vertically arranged cylindrical structure, the turret base 102 is arranged coaxially with the turret main body 103, the top of the turret main body 103 is fixedly provided with a turret cover plate 105, the rotation axis of the first rotation assembly 2 passes through the turret base 102 from bottom to top and extends into the interior of the turret main body 103, and the first rotation assembly 2 is connected to the bottom face of the turret base 102, so that the turret main body 103 is driven to rotate through the first rotation assembly 2.

In an alternative embodiment of the present disclosure, as shown in FIGS. 1 to 3, the first rotation assembly 2 includes a base plate 201, and the base plate 201 is a horizontally arranged circular plate structure. A first column body 205 is disposed at a center of a top of the base plate 201. The first column body 205 is a vertically arranged hollow cylindrical structure, the bottom of the first column body 205 is fixedly connected to the base plate 201 by a plurality of bolts. During the assembly of the first rotation assembly 2 and the grating turret assembly 1, the first column body 205 passes through the turret base 102 from bottom to top and extends into the interior of the turret main body 103. The top of the base plate 201 is provided with a first worm gear 202, the first worm gear 202 is rotatably sleeved on an outer periphery of the first column body 205, and the first worm gear 202 is rotatable relative to the base plate 201. The turret base 102 is positioned above the first worm gear 202, and the bottom face of the turret base 102 is connected to a top face of the first worm gear 202 by a positioning pin, so that when the first worm gear 202 rotates, the first worm gear 202 can drive the turret base 102 to rotate synchronously, enabling switching between different grating elements 101.

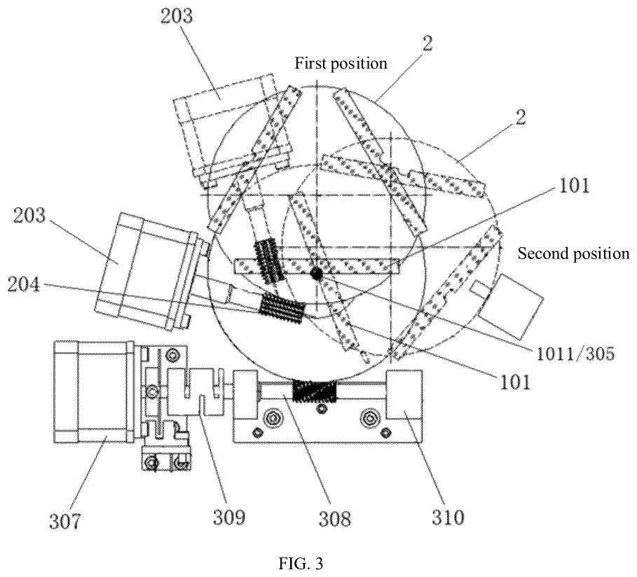

Further, as shown in FIGS. 1 and 3, the first motor 203 and the first worm 204 are provided on the base plate 201 and located on a side of the first worm gear 202, the output shaft of the first motor 203 is connected to an end of the first worm 204, the outer wall of the other end or close to the other end is provided with teeth, and the teeth on the first worm 204 mesh with the teeth on the annular outer edge of the first worm gear 202, so as to drive the first worm 204 to rotate through the output shaft of the first motor 203, drive the first worm gear 202 to rotate through the first worm 204 and provide the power for switching the grating elements 101.

Further, as shown in FIG. 2, the first rotation assembly 2 further includes a vertically disposed first central rotation axis 206, a bottom end of the first central rotation axis 206 is fixedly connected to a central position of the first worm gear 202, the first central rotation axis 206 passes through the bottom opening of the first column body 205 from bottom to top and extends into the interior of the first column body 205, and a first angular contact ball bearing 207 is provided between the first central rotation axis 206 and the inner wall of the first column body 205 to ensure stable rotation of the first central rotation axis 206. The first central rotation axis 206 is the rotation axis of the first rotation assembly 2.

Optionally, as shown in FIG. 2, the number of first angular contact ball bearings 207 is two, and the two first angular contact ball bearings 207 are respectively located at the upper part and the lower part of the first central rotation axis 206, thereby ensuring the stable rotation of the first central rotation axis 206 and improving the rotation accuracy.

In the above-described embodiment of the present application, the base plate 201, the first worm gear 202, the first column body 205, the first central rotation axis 206, the turret base 102, and the turret main body 103 are all arranged coaxially.

In an alternative embodiment of the present disclosure, as shown in FIGS. 1 to 3, the second rotation assembly 3 includes a base 301 provided on the mounting table 4, a rotatable turntable 302 is provided above the base 301, the turntable 302 is a disc-shaped structure arranged along the horizontal direction, a top of the turntable 302 is provided with a second worm gear 303, a top face of the second worm gear 303 is connected to the bottom face of the connection plate 304 by a plurality of bolts, and a top face of the connection plate 304 is connected to a bottom of the base plate 201. When the second worm gear 303 rotates, it drives the connection plate 304 and the base plate 201 to rotate synchronously, thereby actuating the integrated rotation of grating turret assembly 1 and the first rotation assembly 2. This achieves the purpose of driving the wavelength of the corresponding grating element 101 on the grating tower assembly 1 to perform optical axis scanning.

Further, as shown in FIGS. 1 and 3, the second motor 307 and the second worm 308 are provided on the mounting table 4 and located on a side of the second worm gear 303, the output shaft of the second motor 307 is connected to an end of the second worm 308, the outer wall of the other end or close to the other end is provided with teeth, and the teeth on the second worm 308 are meshed with the teeth on the annular outer edge of the second worm gear 303. This configuration allows the second motor 307 to drive the second worm 308 to rotate, thereby driving the second worm gear 303 to rotate and providing the driving force for scanning of the grating element 101 along the optical axis.

Specifically, as shown in FIG. 2, a vertically disposed second column body 3021 protrudes upward at a center position of the top of the turntable 302, the second worm gear 303 is sleeved around the outer periphery of the second column body 3021, and the second worm gear 303 is connected to the turntable 302 by a bolt. The outer periphery of the second column body 3021 is also sleeved with a connection plate 304, the connection plate 304 is located between the top face of the second worm gear 303 and the bottom face of the base plate 201, and the second worm gear 303 is connected to the base plate 201 by the connection plate 304.

Further, as shown in FIG. 3, the second rotation assembly 3 further includes a worm bracket 310 disposed on the mounting table 4, both two ends of the second worm 308 are rotatably disposed on the worm bracket 310, and an end of the second worm 308 is connected to the output shaft of the second motor 307 through the coupling 309. The worm bracket 310 provides a function of rotational support for the second worm 308, and the coupling 309 ensures stable connection and transmission between the second motor 307 and the second worm 308.

Further, as shown in FIG. 2, the second rotation assembly 3 further includes a vertically disposed second central rotation axis 305, the base 301 is provided with a mounting hole 3011 extending vertically, the second central rotation axis 305 is rotatably disposed in the mounting hole 3011, and a top end of the second central rotation axis 305 extends from a top opening of the mounting hole 3011 and is connected to the bottom face of the turntable 302. A second angular contact ball bearing 306 is provided between the second central rotation axis 305 and the inner wall of the mounting hole 3011. The base 301 and the second central rotation axis 305 cooperate to provide rotational support for the whole double-layer turret multi-grating on-axis rotation module.

Optionally, as shown in FIG. 2, the number of second angular contact ball bearings 306 is two, and the two second angular contact ball bearings 306 are respectively located at the upper part and the lower part of the second central rotation axis 305, thereby ensuring stable rotation of the second central rotation axis 305 and improving rotation accuracy.

In the above embodiment, a distance between an axis of the first central rotation axis 206 and an axis of the second central rotation axis 305 is equal to a distance between the axis of the first central rotation axis 206 and a vertical centerline 1011 of the grating element 101. In this embodiment, the vertical centerline 1011 of the grating element 101 is the vertical centerline of the grating element 101 along the length direction of the grating element 101 in FIG. 1, so that during the rotation of the first rotation assembly 2 driven by the second rotation assembly 3, for example, the first rotation assembly 2 in FIG. 3 is rotated from a first position to a second position, the grating element 101 receiving light only rotates along its vertical centerline 1011, and the vertical centerline 1011 of the grating element 101 receiving light always remains on a same vertical line as the rotation axis of the second rotation assembly 3 (that is, the central axis of the second rotation assembly 3). This guarantees the on-axis rotation of the grating elements 101, effectively improves the utilization efficiency of the grating elements 101, and thereby enhances the instrument performance of the spectrometer under the same conditions.

In the above-described embodiment of the present application, the second central rotation axis 305, the turntable 302, the second worm gear 303, and the second column body 3021 are all arranged coaxially.

In an alternative embodiment of the present disclosure, as shown in FIG. 1, the second rotation assembly 3 further includes a limit pin 311 and a tension spring 312. The limit pin 311 is fixedly disposed on the mounting table 4. The tension spring 312 extends in a horizontal direction, and an end of the tension spring 312 is connected to the limit pin 311, and the other end of the tension spring 312 is connected to an edge of the turntable 302. When the turntable 302 rotates synchronously with the second worm gear 303, the tension spring 312 limits the rotation range of the second worm gear 303, ensuring that the grating element 101 completes its scanning operation within the defined range. In addition, the pulling force of the tension spring 312 on the turntable 302 can also eliminate the meshing gap (i.e., the backlash) between the second worm gear 303 and the second worm 308 when the second worm gear 303 returns to zero (i.e., the second worm gear 303 needs to be restored to a preset starting position before rotation). This ensures a stable meshing relationship between the second worm gear 303 and the second worm 308, thereby achieving the purpose of stable transmission.

In an alternative embodiment of the present disclosure, as shown in FIG. 1, the second rotation assembly 3 further includes a first photoelectric sensor 313, and the first photoelectric sensor 313 may be arranged on the base 301. The turntable 302 is provided with a corresponding light-transmitting hole. When the turntable 302 is rotated to a position where its light-transmitting hole is aligned with the first photoelectric sensor 313, light passes through the light-transmitting hole and is received by the first photoelectric sensor 313. The first photoelectric sensor 313 can be configured to collect the optical signal, and analysis of the captured optical signal to determine the rotation angle of the second worm gear 303. This can be used for positioning the wavelength scanning range of the grating. Of course, the positions of the first photoelectric sensor 313 and the light-transmitting hole can also be swapped, that is, the first photoelectric sensor 313 is installed on the turntable 302, and the light-transmitting hole is arranged on the base 301.

In an alternative embodiment of the present disclosure, as shown in FIGS. 1 and 2, the first worm gear 202 is provided with a plurality of light-transmitting holes 2022 at positions near an edge thereof, the plurality of light-transmitting holes 2022 correspond one-to-one with the plurality of grating elements 101, and the plurality of light-transmitting holes 2022 are uniformly arranged at intervals along a circumference of the first worm gear 202. The first rotation assembly 2 further includes a second photoelectric sensor 208 arranged on the mounting table 4, and the second photoelectric sensor 208 is located on a side of the first worm gear 202. During the rotation process of the first worm gear 202, when the light-transmitting hole 2022 aligns with the position of the second photoelectric sensor 208, there is light received by the second photoelectric sensor 208 after passing through the light-transmitting hole 2022. Based on the received optical signal and a time interval between two consecutive optical signals, the rotational speed of the first worm gear 202 and the positions of the different grating elements 101 can be determined, thereby enabling precise switching and positioning of the grating elements 101. The second photoelectric sensor 208 can respectively collect the corresponding optical signal when the plurality of light-transmitting holes 2022 are sequentially rotated to align with the corresponding positions thereof, so that the rotational positions of each grating element 101 can be obtained, and the purpose of switching and positioning the grating can be achieved.

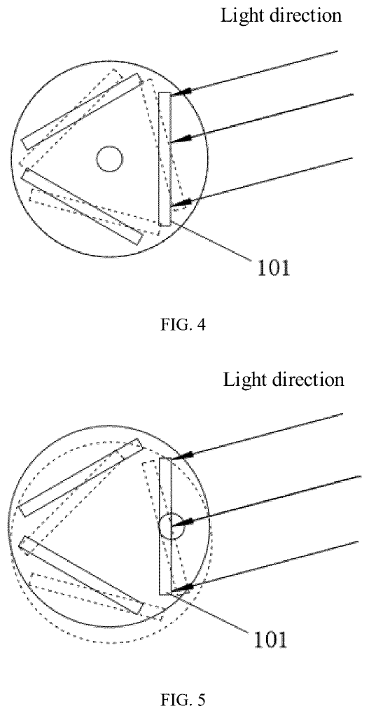

In a comparative embodiment of the present disclosure, as shown in FIG. 4, when the grating element 101 is rotated off-axis (i.e., the plurality of grating elements 101 rotate around a vertical axis located at their center), when the grating element 101 is rotated from the solid-line position in FIG. 4 to the dashed-line position, the rotation axis of the grating element 101 itself at the light receiving position (i.e., the vertical centerline 1011 of the grating element 101 described above) will deviate, resulting in a reduction in the clear aperture (light transmission area) of the grating element 101 and a reduction in the utilization efficiency of the grating element 101. As shown in FIG. 5, when the grating element 101 of the present application undergo on-axis rotation, the rotation axis of the grating element 101 located at the light receiving position (that is, the vertical centerline 1011 of the grating element 101 described above) does not deviate, and the grating element 101 located at the light receiving position rotates on its own rotation axis, so that the grating element 101 always maintains a constant clear aperture throughout. Thus, compared to the off-axis rotation approach, the dual-layer turret multi-grating on-axis rotation module of the present application improves the utilization efficiency of the grating element 101.

The double-layer turret multi-grating on-axis rotation module of the present disclosure has the characteristics and advantages as follows:
1, In the double-layer turret multi-grating on-axis rotation module, through the cooperation of a plurality of grating elements 101, the first rotation assembly 2 and the second rotation assembly 3, even when switching between different grating elements 101, the rotation axis of the grating elements 101 receiving light and the second rotation assembly 3 can always be maintained on a same vertical line, thus avoiding the problem that the rotation axis deviation in the existing spectrometer with multiple gratings, realizing the on-axis rotation of the grating, and effectively improving the utilization efficiency of the grating.
2, In the double-layer turret multi-grating on-axis rotation module, the first rotation assembly 2 and the second rotation assembly 3 employ a meshing mechanism of worm gears and worms to realize the rotating drive of the grating turret assembly 1, has strong structural stability, and at the same time reduces the complexity of step calculation associated with using multiple driving methods, and simplifies operation.
3. In the double-layer turret multi-grating is on-axis rotation module, the first rotation assembly 2 and the second rotation assembly 3 utilize a meshing mechanism of worm gears and worms for rotation drive, and the assembly of the central rotation axis is realized by using paired angular contact ball bearings, so as to ensure higher stability and rotating accuracy in the rotating process.
4. In the double-layer turret multi-grating on-axis rotation module, the first rotation assembly 2 and the second rotation assembly 3 can respectively realize rotation detection and positioning through corresponding photoelectric sensors, providing high positioning accuracy. In addition, the second rotation assembly 3 adopts the tension spring 312 to limit the rotational range of the second rotation assembly 3, that is, the limit of the wavelength scanning range is realized. This serves as a coarse limiting and error prevention mechanism. The tension spring 312 also functions to eliminate backlash between the second worm gear 303 and the second worm 308, ensuring a stable meshing relationship between the second worm gear 303 and the second worm 308 and consequently achieving stable power transmission.

### Embodiment 2

The present disclosure provides a spectrometer, and the spectrometer includes the above-mentioned double-layer turret multi-grating on-axis rotation module.

The spectrometer of the present disclosure has the same characteristics and advantages as the above-mentioned double-layer turret multi-grating on-axis rotation module, and will not be repeatedly described here.

The above description is merely an illustrative embodiment of the present disclosure, and is not intended to limit the scope of the present disclosure. Any equivalent changes and modifications made by those skilled in the art without departing from the concept and principles of the present disclosure should fall within the scope of protection of the present disclosure.

What is claimed is:

1. A double-layer turret multi-grating on-axis rotation module, characterized in that the double-layer turret multi-grating on-axis rotation module comprises:
a grating turret assembly, wherein the grating turret assembly comprises a turret base and a plurality of grating elements with different spectral resolutions, and the plurality of grating elements are vertically arranged on a top face of the turret base, and the plurality of grating elements are arranged in a coordinated manner to form a polygonal prism structure;
a first rotation assembly, wherein the first rotation assembly is disposed below the grating turret assembly, a bottom face of the turret base is connected to the top of the first rotation assembly, a rotation axis of the first rotation assembly is on a same vertical line as a central axis of a plurality of grating elements, and the grating turret assembly is driven to rotate by the first rotation assembly to change the grating elements receiving light; and
a second rotation assembly, wherein the second rotation assembly is disposed below the first rotation assembly, a bottom of the first rotation assembly is connected to a top of the second rotation assembly, and a rotation axis of the second rotation assembly is offset vertically from the rotation axis of the first rotation assembly;
wherein in a horizontal direction, the distance between the rotation axis of the second rotation assembly and the rotation axis of the first rotation assembly is equal to the distance between the rotation axis of the first rotation assembly and the grating element, so that the grating element receiving light and the rotation axis of the second rotation assembly are located on a same vertical line, and the first rotation assembly is driven to rotate by the second rotation assembly.

2. The double-layer turret multi-grating on-axis rotation module according to claim 1, wherein the grating turret assembly further comprises a turret main body, the bottom of the turret main body is connected to the top face of the turret base, the outer wall of the turret main body and along the circumferential direction thereof are provided with a plurality of grating brackets, the plurality of grating brackets correspond one-to-one with the plurality of grating elements, and the plurality of grating elements are respectively detachably connected to the corresponding grating brackets.

3. The double-layer turret multi-grating on-axis rotation module according to claim 2, wherein the turret main body is a vertically arranged cylindrical structure, a top of the turret main body is provided with a turret cover plate, the rotation axis of the first rotation assembly passes through the turret base from bottom to top and extends into the interior of the turret main body, and the first rotation assembly is connected to the bottom face of the turret base, so that the turret main body is driven to rotate through the first rotation assembly.

4. The double-layer turret multi-grating on-axis rotation module according to claim 3, wherein the first rotation assembly comprises a base plate, a first column body is disposed at a center of a top of the base plate, the first column body is a vertically arranged hollow columnar structure, a bottom of the first column body is connected to the base plate, and the first column body passes through the turret base from bottom to top and extends into the interior of the turret main body;
the top of the base plate is provided with a first worm gear, the first worm gear is rotatably sleeved on an outer periphery of the first column body, the turret base is positioned above the first worm gear, and the bottom face of the turret base is connected to a top face of the first worm gear; and
a side of the first worm gear is provided with a first motor and a first worm, an output shaft of the first motor is connected to an end of the first worm, and teeth on the first worm are meshed with teeth on the first worm gear to drive the first worm gear to rotate through the first motor.

5. The double-layer turret multi-grating on-axis rotation module according to claim 4, wherein the first rotation assembly further comprises a first central rotation axis, a bottom end of the first central rotation axis is connected to the first worm gear, and the first central rotation axis passes through the bottom opening of the first column body from bottom to top and extends into the interior of the first column body;
a first angular contact ball bearing is provided between the first central rotation axis and the inner wall of the first column body.

6. The double-layer turret multi-grating on-axis rotation module according to claim 4, wherein the first motor is disposed on the base plate.

7. The double-layer turret multi-grating on-axis rotation module according to claim 5, wherein the second rotation assembly comprises a base provided on a mounting table, a rotatable turntable is provided above the base, a second worm gear is provided at a top of the turntable, a top face of the second worm gear is connected to the bottom face of a connection plate, and a top face of the connection plate is connected to a bottom of the base plate; and
a side of the second worm gear is provided with a second motor and a second worm, an output shaft of the second motor is connected to an end of the second worm, and teeth on the second worm are meshed with teeth on the second worm gear to drive the second worm gear to rotate through the second motor.

8. The double-layer turret multi-grating on-axis rotation module according to claim 7, wherein a second column body protrudes upward from a center position of the top of the turntable, the second worm gear is sleeved on the outer periphery of the second column body, and the second worm gear is connected to the turntable by a bolt; and
the outer periphery of the second column body is sleeved with a connection plate, the connection plate is located between the top face of the second worm gear and the bottom face of the base plate, and the second worm gear is connected to the base plate by the connection plate.

9. The double-layer turret multi-grating on-axis rotation module according to claim 7, wherein the second rotation assembly further comprises a worm bracket arranged on the mounting table, the second worm is rotatably disposed on the worm bracket, and an end of the second worm is connected to the output shaft of the second motor through a coupling.

10. The double-layer turret multi-grating on-axis rotation module of claim 7, wherein the second rotation assembly further comprises a second central rotation axis, the base is provided with a mounting hole extending vertically, the second central rotation axis is rotatably disposed in the mounting hole, a top end of the second central rotation axis extends from a top opening of the mounting hole and is connected to a bottom face of the turntable; and
a second angular contact ball bearing is provided between the second central rotation axis and the inner wall of the mounting hole.

11. The double-layer turret multi-grating on-axis rotation module of claim 10, wherein a distance between an axis of the first central rotation shaft and an axis of the second central rotation shaft is equal to a distance between the axis of the first central rotation shaft and a vertical centerline of the grating element.

12. The double-layer turret multi-grating on-axis rotation module according to claim 7, wherein the second rotation assembly further comprises a limit pin and a tension spring, wherein the limit pin is disposed on the mounting table, an end of the tension spring is connected to the limit pin, and the other end of the tension spring is connected to the turntable to limit the rotation range of the second worm gear.

13. The double-layer turret multi-grating on-axis rotation module of claim 7, wherein the second rotation assembly further comprises a first photoelectric sensor, and the first photoelectric sensor is configured to collect an optical signal to determine a rotational angle of the second worm gear.

14. The double-layer turret multi-grating on-axis rotation module of claim 12, wherein the second rotation assembly further comprises a first photoelectric sensor, and the first photoelectric sensor is configured to collect an optical signal to determine a rotational angle of the second worm gear.

15. The double-layer turret multi-grating on-axis rotation module according to claim 4, wherein the first worm gear is provided with a plurality of light-transmitting holes at positions near an edge thereof, the plurality of light-transmitting holes correspond one-to-one with the plurality of grating elements, and the plurality of light-transmitting holes are distributed at intervals along a circumference of the first worm gear; and
the first rotation assembly further comprises a second photoelectric sensor arranged on the mounting table, and the second photoelectric sensor is located on a side of the first worm gear, and the second photoelectric sensor is configured to respectively collect corresponding optical signals when the plurality of light-transmitting holes are sequentially rotated to a position aligned with it.

16. The double-layer turret multi-grating on-axis rotation module according to claim 1, wherein the number of grating elements is three, and among the three grating elements, the grating element located on a same vertical line as the rotation axis of the second rotation assembly faces an incident direction of the light.

17. A spectrometer, wherein the spectrometer comprises a double-layer turret multi-grating on-axis rotation module,
wherein the double-layer turret multi-grating on-axis rotation module comprises:
a grating turret assembly, wherein the grating turret assembly comprises a turret base and a plurality of grating elements with different spectral resolutions, and the plurality of grating elements are vertically arranged on a top face of the turret base, and the plurality of grating elements are arranged in a coordinated manner to form a polygonal prism structure;
a first rotation assembly, wherein the first rotation assembly is disposed below the grating turret assembly, a bottom face of the turret base is connected to the top of the first rotation assembly, a rotation axis of the first rotation assembly is on a same vertical line as a central axis of a plurality of grating elements, and the grating turret assembly is driven to rotate by the first rotation assembly to change the grating elements receiving light; and
a second rotation assembly, wherein the second rotation assembly is disposed below the first rotation assembly, a bottom of the first rotation assembly is connected to a top of the second rotation assembly, and a rotation axis of the second rotation assembly is offset vertically from the rotation axis of the first rotation assembly;
wherein in a horizontal direction, the distance between the rotation axis of the second rotation assembly and the rotation axis of the first rotation assembly is equal to the distance between the rotation axis of the first rotation assembly and the grating element, so that the grating element receiving light and the rotation axis of the second rotation assembly are located on a same vertical line, and the first rotation assembly is driven to rotate by the second rotation assembly.

18. The spectrometer according to claim 17, wherein the grating turret assembly further comprises a turret main body, the bottom of the turret main body is connected to the top face of the turret base, the outer wall of the turret main body and along the circumferential direction thereof are provided with a plurality of grating brackets, the plurality of grating brackets correspond one-to-one with the plurality of grating elements, and the plurality of grating elements are respectively detachably connected to the corresponding grating brackets.

19. The spectrometer according to claim 18, wherein the turret main body is a vertically arranged cylindrical structure, a top of the turret main body is provided with a turret cover plate, the rotation axis of the first rotation assembly passes through the turret base from bottom to top and extends into the interior of the turret main body, and the first rotation assembly is connected to the bottom face of the turret base, so that the turret main body is driven to rotate through the first rotation assembly.

20. The spectrometer according to claim 19, wherein the first rotation assembly comprises a base plate, a first column body is disposed at a center of a top of the base plate, the first column body is a vertically arranged hollow columnar structure, a bottom of the first column body is connected to the base plate, and the first column body passes through the turret base from bottom to top and extends into the interior of the turret main body;
the top of the base plate is provided with a first worm gear, the first worm gear is rotatably sleeved on an outer periphery of the first column body, the turret base is positioned above the first worm gear, and the bottom face of the turret base is connected to a top face of the first worm gear; and
a side of the first worm gear is provided with a first motor and a first worm, an output shaft of the first motor is connected to an end of the first worm, and teeth on the first worm are meshed with teeth on the first worm gear to drive the first worm gear to rotate through the first motor.
